(19) United States
(12) Patent Application Publication
(10) Pub. No.: US 2018/0146765 A1
(43) Pub. Date: May 31, 2018

(54) LIQUID CONTENTS DISCHARGE CONTAINER HAVING ABSORPTION MEMBER

(71) Applicant: YONWOO CO., LTD., Incheon (KR)

(72) Inventors: Jae Ock Lee, Incheon (KR); Seung Hwan Kim, Incheon (KR)

(21) Appl. No.: 15/576,314

(22) PCT Filed: May 27, 2015
(86) PCT No.: PCT/KR2015/005285

§ 371 Date: Nov. 22, 2017

(30) Foreign Application Priority Data
May 26, 2015 (KR) 10-2015-0072625

(51) Int. Cl. A45D 34/04; B65D 83/00; B05B 11/02

(52) U.S. Cl. CPC A45D 34/04; A45D 2200/055; B05B 11/02; B65D 83/0011

(57) ABSTRACT

A liquid contents discharge container includes an absorption member configured in a way that when a rotation body rotates, liquid contents are discharged in an extrusion manner while a piston is ascending, and are absorbed into an absorption member to be used, such that it is possible to provide the same usability as a solid lipstick product which is familiar with users and to improve wearability of liquid contents, and by equipping a nozzle which opens only when contents are discharged, to prevent air from flowing into the interior of the container body when not in use.

### BACKGROUND

The present disclosure relates to a liquid contents discharge container having absorption member, and more particularly, to a liquid contents discharge container having absorption member configured in a way that when a rotation body rotates, liquid contents are discharged in an extrusion manner while a piston is ascending, and are absorbed into an absorption member to be used, such that it is possible to provide the same usability as a solid lipstick product which is familiar with users and to improve wearability of liquid contents, and by equipping a nozzle which opens only when contents are discharged, to prevent air from flowing into the interior of the container body when not in use.

Generally, cosmetic products such as lipsticks is configured to open a cap, rotate a rotation body provided at a lower portion of a container thereof, and raise/lower a solid lipstick to the outside of the container. For example, when a user wants to use a lipstick, firstly the user opens a cap of a container, rotates a rotation body, and raises the lipstick to the outside to be protruded. After using the lipstick, the user lowers the lipstick, and makes the lipstick received in the container.

“A lipstick container” with a configuration as the above is disclosed in FIG. 1 of the registered utility model no. 20-0241614 (hereafter called as the registered utility model).

The registered utility model is characterized in that a lipstick (2) is fitted into a lipstick holder (3), and the lipstick holder (3) and a rotation tube (5) are coupled as a fixing protrusion (4) of the lipstick holder (3) is being fitted into a helical groove (6) formed at an inner portion of the rotation tube (5). A guide tube (7) is inserted between the lipstick holder (3) and the rotation tube (5), and coupled to the rotation tube (5) by an annulus protrusion (5). Meanwhile, the fixing protrusion (4) of the lipstick holder (3) is disposed inside a guide groove (8) of the guide tube (7) and, at the same time, at the helical groove (6).

The registered utility model is configured in a way that the fixing protrusion (4) hung between the helical groove (6) and the guide groove (8) ascends when a user holds the guide tube (7) with a hand and rotates the rotation tube (5), and thereby the lipstick (2) fitted in the lipstick holder (3) ascends along for applying lip make up by means of the lipstick (2); however, this type of lipsticks composed of a solid lipstick as in the above has a problem in that ingredients of the lipstick are likely to be spoiled by being contacted with air.

Due to this, recently, there have been developed a variety of lipstick containers which are possible to minimize decomposition of contents thereof by using liquid lipstick with the lipstick smeared on a brush like a manicure or using the liquid lipstick discharged by squeezing the liquid lipstick stored in the container with a piston.

### SUMMARY OF THE DISCLOSURE

The present embodiments are devised to solve the said problems above, and its goal is to provide a liquid contents discharge container having absorption member configured in a way that when a rotation body rotates, liquid contents are discharged in an extrusion manner while a piston is ascending, and are absorbed into an absorption member to be used, such that it is possible to provide the same usability as a solid lipstick product which is familiar with users and to improve wearability of liquid contents, and by equipping a nozzle which opens only when contents are discharged, to prevent air from flowing into the interior of the container body when not in use.

To solve the above problems, a cosmetic container for discharging liquid having absorption member includes: a container body storing liquid contents and provided with a discharge part at an upper portion thereof where contents are discharged; a rotation body encasing a lower portion of the container body and rotatably coupled, further provided with an ascending/descending guide member which extends upwards from an inner lower end thereof; a piston rod which is screw-coupled to the ascending/descending guide member and ascends/descends according to rotation of the rotation body; a piston which is coupled to an upper portion of the piston rod and moves along the ascent/descent of the piston rod, and closely contacted to an inner wall of the container body; an absorption member coupled, encasing an upper portion of the container body, and made of porous material and absorbing liquid contents; a nozzle part which is inserted to an inner side of the discharge part and prevents air from flowing into the discharge part when not in used, opens only when contents are discharged and moves liquid contents stored in the container body to the absorption member; and an over cap rotatably coupled, encasing an upper portion of the container body.

It is characterized to be configured in a way that, when the rotation body is rotated to one side direction, liquid contents stored in the container body are discharged in an extrusion manner according to the piston rod and the piston ascending, and the nozzle part opens by pressure of liquid contents, such that the liquid contents discharged are absorbed into the absorption member.

It is characterized in a way that the nozzle part includes: an inner nozzle, further including a coupling part which is inserted to an inner side of the discharge part and provided with a contents inflow hole communicating with the discharge part, and a blocking rod protrusively formed upwards from a center part of the coupling part; an outer nozzle which encases the blocking rod and mounted to an upper end of the coupling part and ascends/descends according to the discharge of the contents; a fixation body encasing the outer nozzle and coupled to the discharge part, further provided with a hollow such that the outer nozzle can ascend/descend; and an elastic body disposed at an inner side of the fixation body and encasing the outer nozzle, and thereby descending the outer nozzle.

Furthermore, it is characterized in a way that the nozzle part includes: an inner nozzle, further including a coupling part which is inserted to an inner side of the discharge part and provided with a contents inflow hole communicating with the discharge part, and a blocking rod protrusively formed upwards from a center part of the coupling part; an outer nozzle which encases the blocking rod and mounted to an upper end of the coupling part and ascends/descends according to the discharge of the contents; and a fixation body which encases the outer nozzle, is coupled to the discharge part, and provided with a hollow such that the outer nozzle can ascend/descend.

Wherein the outer nozzle, having an upper end thereof contacted to an inner side of the absorption member, deforms the absorption member in a process of ascending by pressure of contents, and then descends by the restoration of the absorption member by own force.

Furthermore, it is characterized in that at an inner side of the container body is formed a perpendicular guide groove which guides the perpendicular movement of the piston rod, and at an outer circumferential surface of the piston rod is formed a guide protrusion which is inserted to the perpendicular guide groove and ascends/descends along the perpendicular guide groove.

As mentioned in the above, the present disclosure is configured in a way that when a rotation body rotates, liquid contents are discharged in an extrusion manner while a piston is ascending, and are absorbed into an absorption member to be used, such that it is possible to provide the same usability as a solid lipstick product which is familiar with users and to improve wearability of liquid contents, and by equipping a nozzle which opens only when contents are discharged, to prevent air from flowing into the interior of the container body when not in use.

### BRIEF DESCRIPTION OF THE DRAWINGS

FIG. 1 is an exploded perspective view illustrating a configuration of to a liquid contents discharge container having absorption member according to an exemplary embodiment.

FIG. 2 is an assembled perspective view illustrating a configuration of to a liquid contents discharge container having absorption member according to an exemplary embodiment.

FIG. 3 is a cross-sectional view illustrating a configuration to a liquid contents discharge container having absorption member according to an exemplary embodiment.

FIGS. 4 to 6 are explanatory drawings illustrating operational state of to a liquid contents discharge container having absorption member according to an exemplary embodiment.

FIG. 7 is a cross-sectional view illustrating a configuration to a liquid contents discharge container having absorption member according to another exemplary embodiment.

FIGS. 8 to 10 explanatory drawings illustrating operational state of to a liquid contents discharge container having absorption member according to an exemplary embodiment.

### DETAILED DESCRIPTION

Hereinafter, exemplary embodiments will be described in detail with reference to the accompanying drawings. The same reference numerals provided in the drawings indicate the same members.

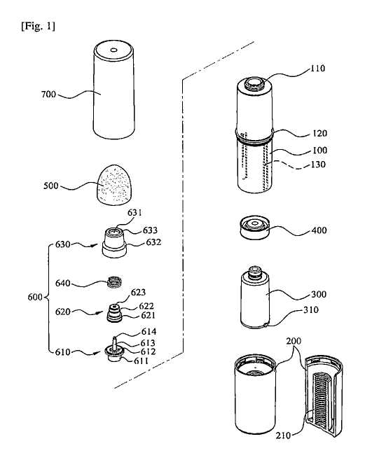

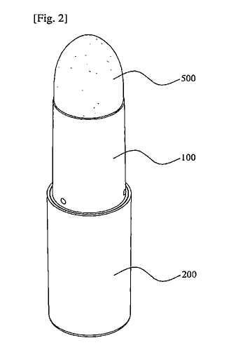

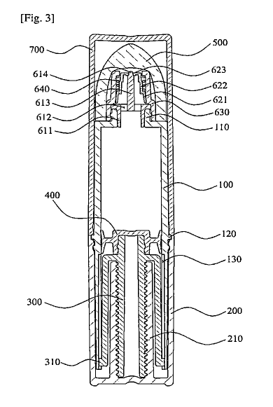

FIG. 1 is an exploded perspective view illustrating a configuration of to a liquid contents discharge container having absorption member according to an exemplary embodiment. FIG. 2 is an assembled perspective view illustrating a configuration of to a liquid contents discharge container having absorption member according to an exemplary embodiment. FIG. 3 is a cross-sectional view illustrating a configuration to a liquid contents discharge container having absorption member according to an exemplary embodiment.

Referring to FIGS. 1 to 3, a liquid contents discharge container having absorption member according to an exemplary embodiment. includes a container body 100, a rotation body 200, a piston rod 300, a piston 400, an absorption member 500, a nozzle part 600, and an over cap 700.

The container body 100, storing liquid contents, and provided with a discharge part 110 at an upper portion thereof such that stored contents can be discharged, is preferred to be made of transparent material such that it is possible to check the color of stored contents from the outside of the container body 100.

The container body 100 is composed of a cylinder shape with a predetermined length such that a piston rod 300 and a piston 400 can ascend/descend at an interior of the container body 100, and at an outer circumferential surface thereof is equipped a compartment protrusion 120 which comparts a space where a rotation body 200 and an over cap 700, which are described later, are coupled.

Furthermore, at both inner sides of the container body 100 are installed a pair of perpendicular guide groove 130 where a guide protrusion 310 of the piston rod 300 are inserted such that the piston rod 300 can move perpendicularly.

The rotation body 200, encasing a lower portion of the container body 100 and rotatably coupled is characterized to be equipped with an ascending/descending member 210, at a lower side of the rotation body 200, which extends upwards from a lower end thereof.

The ascending/descending member 210 has screw threads formed at an inner circumferential surface and is screw-coupled with a piston rod 300, to be described later. Due to this, it is possible that the piston 300 can ascend/descend according to rotation of the rotation body 200. When the rotation body 200 rotates to one side, the piston rod 300 and the piston 400 ascend, and thereby liquid contents stored in the container body 100 are pressurized and move to an upper portion thereof, such that a nozzle part 600 is opened by pressure of the contents and then, are absorbed into an absorption member 500, and thereby, it is possible to apply contents through the absorption member 500.

The piston rod 300 is screw-coupled to the ascending/descending member 210 and ascends/descends according to rotation of the rotation body 200. A screw thread is formed at an outer circumferential surface of the piston rod 300 such that it is possible to be screw-coupled with the ascending/descending member 210.

Furthermore, at an outer circumferential surface of the piston rod 300 are equipped a guide protrusion 310 which is respectively inserted to a pair of perpendicular guide grooves 130 and ascends/descends along the perpendicular guide groove 130 when the rotation body 200 rotates.

The piston 400, which is coupled to an upper portion of the piston rod 300 and moves along with the ascent/descent of the piston rod 300, is configured to be contacted to an inner wall of the container body 100 and ascends/descends. Due to this, when the piston rod 400 ascends, it is possible for the piston 400 to discharge in an extrusion manner by pressurizing liquid contents stored in the container body 100

The absorption member 500, which encases a nozzle part 600 at an upper portion of the container body 100 and coupled, is composed of a porous material which absorbs liquid contents discharged through the nozzle part 600, thereby improving wearablity when a user applies lipstick on her lips.

Furthermore, the absorption member 500 is preferred to be made of a shape which gets narrower towards an upper portion thereof, thereby making it possible to provide the same usability as a solid lipstick product which is familiar with users.

The nozzle part 600, which is inserted to an inner side of the discharge part 110 and prevents air from flowing into the discharge part 110 when not in use, opens only when contents are discharge, and moves liquid contents stored in the container body 100 to the absorption member 500, includes an inner nozzle 610, an outer nozzle 620, a fixation body 630, and an elastic body 640.

The inner nozzle 610 is inserted to an inner side of the discharge part 110, guides contents discharged through the discharge part 110, and opens/closes an outer nozzle 620 to be described later. The inner nozzle 610 comprises a coupling part 611which forms a contents inflow hole 612 communicated with the discharge part 110 at an upper portion thereof such that contents discharged through the discharge part 110 can flow in, and a blocking rod 613 which opens/closes a discharge hole 623 of the outer nozzle 620 according to the ascent/descent of the outer nozzle 620 which is protrusively formed upwards from a center part of the coupling part 611. A protrusion part 614 which protrudes to an exterior of the outer nozzle 620 is preferably formed at an end of the blocking rod 613 such that contents can be prevented from being stuck in a space where the blocking rod 613 and the discharge hole 623 of the out nozzle 620 are formed.

The outer nozzle, which encases the blocking rod 613 and mounted at an upper end of the coupling part 611, and is opened/closed by the blocking rod 613 which ascending/descending according to the discharge of contents, includes a mount part 621 and a contents movement tube 622.

The mount part 621 which is mounted at an upper end of the coupling part 611 of the inner nozzle and supports a lower end of an elastic body 630 encasing the contents movement tube 622, thereby making the elastic body 640 contracted, and when contents discharge is completed, the outer nozzle 620 is descended by elastic force of the elastic body 640.

The mount part 621 is characterized to be composed of a cylinder shape, with a piston structure wherein an upper end and a lower end of the outer circumferential surface of the mount part 621 meet an inner side wall of the fixation body 630. Due to this, while ascending/descending, the outer nozzle 620 is prevented from wobbling, thereby making it possible to steadily discharge contents and to prevent contents from being leaked along an inner wall of the fixation body 630.

The contents movement tube 622, which extends upwards from the mount part 621 and forms a passage such that contents flowing from through a contents inflow how 612 of the inner nozzle 610 can move, is provided with a discharge hole 623 that is opened/closed by the blocking rod 613 at an end thereof such that the contents flowing in can be discharged to the outside.

The fixation body 630, composed of a cylinder shape, encases the outer nozzle 620 and is coupled to the discharge part 110, wherein the fixation body 630 comprises a hollow 631 such that the outer nozzle 620 moving according to the contents discharge can ascend/descend, and comprises a mount protrusion 632 such that the fixation body 630 can be mounted while encasing an outer circumferential surface thereof.

Furthermore, at an upper end of the fixation body 630 is provided an elastic body support protrusion 633 which, with an upper end thereof bent to an inner direction, encases an inner circumferential surface thereof to support an elastic body 640 to be described later, wherein the elastic body support protrusion 633 supports an upper end of the elastic body 640 when the outer nozzle 620 ascends and make the elastic body 640 contracted.

The elastic body 640 is disposed, encasing the outer nozzle 620, at an inner side of the fixation body and makes the outer nozzle 620 descend, wherein one side thereof is mounted on a mount part 621 of the outer nozzle 620 and the other side thereof is configured to meet the elastic body support protrusion 633.

The elastic body 640, when a piston rod 300 and a piston 400 ascend according to one-side rotation of the rotation body 200, is contracted according to the movement of the outer nozzle 620 which ascends by pressure of contents, and then when the piston rod 300 and the piston 400 descend according to the other side rotation of the rotation body 200, the elastic body 640 is released, thereby providing an elastic force to the mount part 621 of the outer nozzle 620 and making the outer nozzle 620 descend.

The over cap 700 encases an upper portion of the container body 100 and is detachably coupled. While not in use, the over cap 700 is coupled to the container body 100 and prevents the absorption member 500 from being contaminated and the contents absorbed in the absorption member 500 from being evaporated.

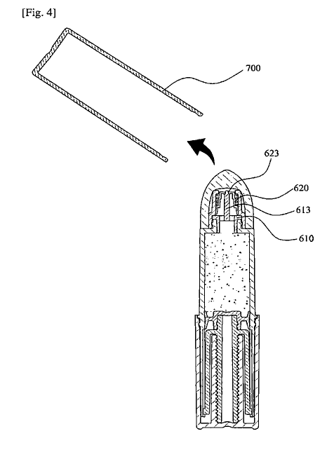

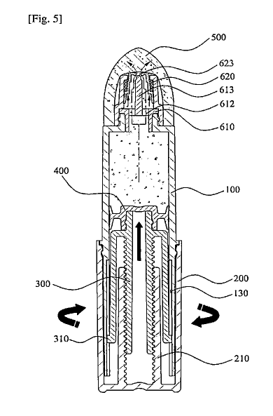

Hereafter, referring FIGS. 4 to 6, the operational state of to a liquid contents discharge container having absorption member according to an exemplary embodiment will be described. FIGS. 4 to 6 are explanatory drawings illustrating operational state of to a liquid contents discharge container having absorption member according to an exemplary embodiment. Referring to FIGS. 4 to 6, when a user grips the container body 100 with one hand in a state of detaching the over cap 700 from the container body 100, and then rotates the rotation body 200 to one-side direction, the piston rod 300 screw-coupled to the ascending/descending guide member 210 ascends. When the piston rod 300 ascends, the piston 400 coupled to an upper portion of the piston rod 300.

As described in the above, as ascending, the piston 400 pressurizes contents stored in the container body 100, and the contents moving by pressurization of the piston 400 flow into the outer nozzle 620 through the contents inflow hole 612. In the process that contents flow into the interior of the outer nozzle 620, the outer nozzle 620 is pressed by the moving contents, and thereby, the outer nozzle 620 ascends by the pressure of the contents.

As in the above, when the outer nozzle 620 ascends, the discharge hole 623 which was closed by the blocking rod 613 of the inner nozzle 610 opens. Therefore, the contents can be discharged through the discharge hole 623 which is opened onto the absorption member 500, thereby making it possible to apply the contents absorbed in the absorption member 500 onto user's lips.

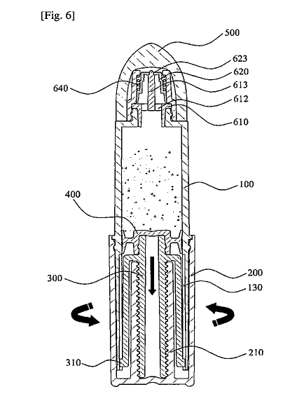

Next, as illustrated in FIG. 6, when rotating the rotation body 200 to the other side direction, the piston rod 300 screw-coupled to the ascending/descending member 210 descends. As the piston rod 300 descends, the piston 400 which is coupled to an upper portion of the piston rod 300 descends together.

As in the above, when the piston descends, the contents stop moving. This time, the outer nozzle 620 moves upwards, and the elastic body 640 is relaxed, therefore providing an elastic force and making the outer nozzle 620 descend. When the outer nozzle 620 descends, the discharge hole 623 is closed by the blocking rod 613 of the inner nozzle 610, making the contents discharged.

As previously described, the presently described embodiments are configured in a way that through the rotation of a rotation body 200, it is possible to get liquid contents stored in the container body 100 to move to an absorption member 500, and to apply the liquid contents, always in a wet state, absorbed in the absorption member 500 by using the absorption member 500 in which liquid contents are absorbed. Therefore, it is possible to provide excellent wearability of liquid contents to users and also possible to prevent air from flowing through the nozzle part 600 when not in use and thereby to be applied to various products such as lipsticks, concealers, and etc.

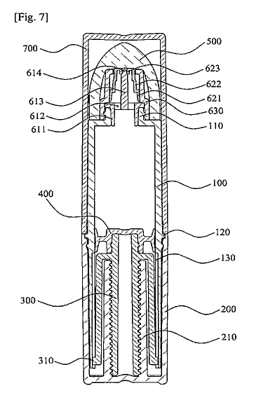

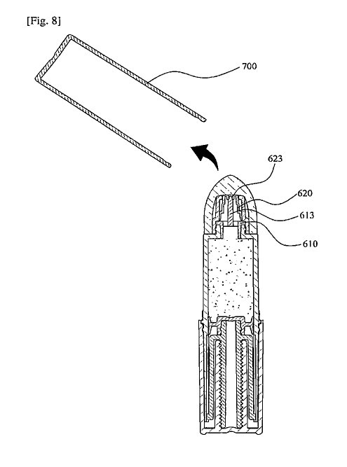

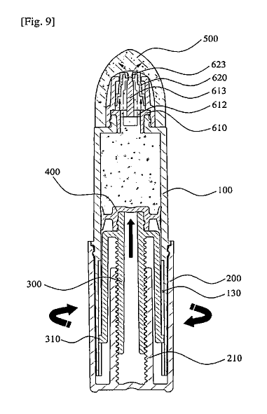

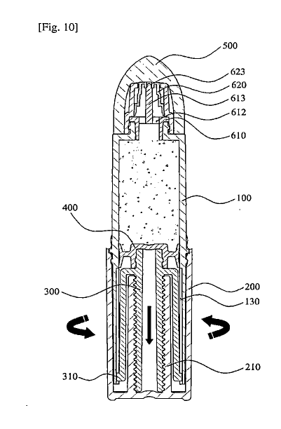

Hereafter, a liquid contents discharge container having absorption member according to another exemplary embodiment will be described on reference to FIG. 7. FIG. 7 is a cross-sectional view illustrating a configuration to a liquid contents discharge container having absorption member according to another exemplary embodiment. Referring to FIG. 7, a liquid contents discharge container having absorption member according to another exemplary embodiment of the present invention, the same as a liquid contents discharge container having absorption member according to an exemplary embodiment, is configured in that the outer nozzle 620 composed of the nozzle part 600 does not descend by the elastic body 640 but by own elastic force. For this, the length of the outer nozzle 620 is made to be long such that the upper end of the outer nozzle 620 composing the nozzle part 600 is disposed in a of being contacted to the inner side of the absorption member 500. As illustrated in FIG. 9, the upper end of the outer nozzle 620 is disposed in a state of the upper end of the outer nozzle 620 being contacted to the inner side of the absorption member 500, so that the upper end of the outer nozzle 620 pressurizes and deforms the absorption member 500 while ascending by pressure of the contents, and then opens the discharge hole 623 to make the contents be discharged.

Meanwhile, after completing the discharge of contents, as illustrated in FIG. 9, when the piston rod 300 and the piston 400 descend as the rotation body 200 is rotated to the other direction, the absorption member 500 pressurizes the upper end of the outer nozzle 620 due to restoration by own elastic force of the absorption member 500. As a result, the outer nozzle 620 descends and the discharge hole 623 is closed by the blocking rod 613, thereby making it possible to prevent outside air from flowing through the discharge hole 623 into the interior of the container body 100.

The remaining structure of a liquid contents discharge container having absorption member according to another exemplary embodiment is the same as the structure and function of an exemplary embodiment as previous descried, and thus a detailed description thereof will be omitted.

As described above, optimal embodiments have been disclosed in the drawings and the specification. Although specific terms have been used herein, these are only intended to describe some of the contemplated embodiments and are not intended to limit the meanings of the terms or to restrict the scope of the accompanying claims. Accordingly, those skilled in the art will appreciate that various modifications and other equivalent embodiments are possible from the above embodiments.

1. A cosmetic container for discharging liquid having absorption member, comprising:
a container body storing liquid contents and provided with a discharge part at an upper portion thereof where contents are discharged;
a rotation body encasing a lower portion of the container body and rotatably coupled, further provided with an ascending/descending guide member which extends upwards from an inner lower end thereof;
a piston rod screw-coupled to the ascending/descending guide member and ascending/descending according to rotation of the rotation body;
a piston coupled to an upper portion of the piston rod and moves along the ascent/descent of the piston rod, and closely contacted to an inner wall of the container body;
an absorption member coupled, encasing an upper portion of the container body and made of porous material and absorbing liquid contents;
a nozzle part inserted to an inner side of the discharge part and preventing air from flowing into the discharge part when not in used, and opening only when contents are discharged and moving liquid contents stored in the container body to the absorption member; and
an over cap rotatably coupled, encasing an upper portion of the container body,
wherein, when the rotation body is rotated to one side direction, liquid contents stored in the container body are discharged in an extrusion manner according to the piston rod and the piston ascending, and the nozzle part opens by pressure of liquid contents, such that the liquid contents discharged are absorbed into the absorption member.

2. The cosmetic container for discharging liquid having absorption member of claim 1,
wherein the nozzle part comprises:
an inner nozzle, further including a coupling part which is inserted to an inner side of the discharge part and provided with a contents inflow hole communicating with the discharge part, and a blocking rod protrusively formed upwards from a center part of the coupling part;
an outer nozzle encasing the blocking rod and mounted to an upper end of the coupling part and ascending/descending according to the discharge of the contents, further comprising a discharge hole opened/closed by the blocking rod;
a fixation body encasing the outer nozzle and coupled to the discharge part, further provided with a hollow such that the outer nozzle can ascend/descend; and
an elastic body disposed at an inner side of the fixation body and encasing the outer nozzle, and thereby descending the outer nozzle.

3. The cosmetic container for discharging liquid having absorption member of claim 1,
wherein the nozzle part comprises:
an inner nozzle, further comprising a coupling part inserted to an inner side of the discharge part and provided with a contents inflow hole communicating with the discharge part, and a blocking rod protrusively formed upwards from a center part of the coupling part;
an outer nozzle encasing the blocking rod and mounted to an upper end of the coupling part and ascending/descending according to the discharge of the contents, further comprising a discharge hole opened/closed by the blocking rod; and
a fixation body encasing the outer nozzle, coupled to the discharge part, and provided with a hollow such that the outer nozzle can ascend/descend,
characterized in that the outer nozzle, having an upper end thereof contacted to an inner side of the absorption member, deforming the absorption member in a process of ascending by pressure of contents, and then descending by the restoration of the absorption member by own force thereof.

4. The cosmetic container for discharging liquid having absorption member of claim 1,
wherein at an inner side of the container body is formed a perpendicular guide groove guiding the perpendicular movement of the piston rod, and at an outer circumferential surface of the piston rod is formed a guide protrusion s inserted to the perpendicular guide groove and ascends/descends along the perpendicular guide groove.
